(19) United States
(12) Patent Application Publication
(10) Pub. No.: US 2013/0070965 A1
(43) Pub. Date: Mar. 21, 2013

(54) IMAGE PROCESSING METHOD AND APPARATUS

(71) Applicants: Soon-geun Jang, Seongnam-si (KR); Dong-kyu Lee, Seoul (KR); Rae-hong Park, Seoul (KR)

(72) Inventors: Soon-geun Jang, Seongnam-si (KR); Dong-kyu Lee, Seoul (KR); Rae-hong Park, Seoul (KR)

(73) Assignees: Industry-University Cooperation Foundation Sogang University, Seoul (KR); Samsung Electronics Co., Ltd., Suwon-si (KR)

(21) Appl. No.: 13/562,568

(22) Filed: Jul. 31, 2012

(30) Foreign Application Priority Data
Sep. 21, 2011 (KR) 10-2011-0095234

(51) Int. Cl. G06K 9/60

(52) U.S. Cl. 382/103

(57) ABSTRACT

An image processing method and apparatus for obtaining a wide dynamic range image, the method including: obtaining a plurality of low dynamic range images having different exposure levels for a same scene; generating motion map representing whether motion occurred, depending on brightness ranks of the plurality of low dynamic range images; obtaining weights for the plurality of low dynamic range images; generating a weight map by combining the weights and the motion map; and generating a wide dynamic range image by fusing the plurality of low dynamic range images and the weight map. According to the image processing method and apparatus, it is possible to accurately detect motion area using a rank map, obtain a wide dynamic range image at a higher operation speed, and reduce a possibility that a phenomenon such as color warping occurs by directly combining images without using a tone mapping process.

### CROSS-REFERENCE TO RELATED PATENT APPLICATION

This application claims the priority benefit of Korean Patent Application No. 10-2011-0095234, filed on Sep. 21, 2011, in the Korean Intellectual Property Office, which is incorporated herein in its entirety by reference.

### BACKGROUND

1. Field of the Invention

The invention relates to an image processing method and apparatus for obtaining a wide dynamic range image.

2. Description of the Related Art

A brightness range used for acquiring and expressing an image in conventional image processing apparatuses is limited compared to the brightness range that a human eye can perceive. A digital image processing apparatuses can only express brightness and color of pixels within a limited range when acquiring or reproducing an image. In particular, when there is both a bright area and a dark area such as when there is a backlight or a light source in part of a dark room, information, contrast, and color of a subject may not be accurately acquired by conventional digital image processing apparatuses. Thus, wide dynamic range imaging is used as a digital image processing technique for supplementing the above shortcoming.

A wide dynamic range image is conventionally obtained by applying weights to a plurality of low dynamic range images and then fusing the plurality of low dynamic range images. However, in a process of obtaining the low dynamic range images, an image overlap phenomenon may occur due to motion of the subject or a change in a background. Thus, it is necessary to detect and compensate for motion of the subject and any change in the background between the low dynamic range images.

Conventional methods of removing the image overlap phenomenon during wide dynamic range imaging include a dispersion-based motion detection method, an entropy-based motion detection method, and a histogram-based motion detection method.

The dispersion-based motion detection method does not satisfactorily detect low contrast between an object and a background or a small amount of motion in a flat area. The entropy-based motion detection method is sensitive to critical values used to find motion area, and does not satisfactorily detect a small amount of motion in a flat area. In addition, the calculation time of the entropy-based motion detection method is excessively long. The histogram-based motion detection method excessively detects an image overlap area by classifying brightness values of an image into levels.

### SUMMARY

The invention provides an image processing method and apparatus that are insensitive to a change in exposure and obtains a wide dynamic range image at high operation speed.

According to an aspect of the invention, there is provided a method of processing an image, the method including: obtaining a plurality of low dynamic range images having different exposure levels for a same scene; generating motion map representing whether motion occurred, depending on brightness ranks of the plurality of low dynamic range images; obtaining weights for the plurality of low dynamic range images; generating a weight map by combining the weights and the motion map; and generating a wide dynamic range image by fusing the plurality of low dynamic range images and the weight map.

The determining whether the motion occurs may include: determining ranks depending on brightness values of pixels in each of the low dynamic range images; generating a rank map based on the determined ranks; obtaining a rank difference between a reference rank map and another rank map in a same pixel position; and generating the motion map in which it is determined that motion has occurred in another image if the rank difference is larger than a critical value, and in which it is determined that motion has not occurred in the other image if the rank difference is less than the critical value.

The method further includes clustering the motion map by applying a morphology calculation to the motion map.

The generating of the weight map may include calculating weights for contrast, saturation, and degree of exposure for each pixel of the plurality of low dynamic range images.

One or two of the weights may be used depending on a calculation time.

the weight for the contrast may be greatest for a pixel corresponding to an edge or texture in each of the low dynamic range images, the weight for the saturation may be greatest for a pixel having a clearer color in each of the low dynamic range images, and the weight for the degree of exposure may increase as an exposure value of a pixel approaches a medium value.

The generating of the wide dynamic range image may include fusing the plurality of low dynamic range images and the weight map using a pyramid decomposition algorithm.

The generating of the wide dynamic range image may include: performing Laplacian pyramid decomposition on the low dynamic range images; performing Gaussian pyramid decomposition on the weight map; and combining a result of the performed Laplacian pyramid decomposition and a result of the performed Gaussian pyramid decomposition.

According to an aspect of the invention, there is provided an apparatus for processing an image, the apparatus including: a provider to obtain a plurality of low dynamic range images having different exposure levels for a same scene; a determination unit to generate motion map representing whether motion is detected depending on brightness ranks of the plurality of low dynamic range images; a generator to obtain weights for the plurality of low dynamic range images and generate a weight map by combining the weights and the motion map; and a fusion unit to generate a wide dynamic range image by fusing the plurality of low dynamic range images and the weight map.

The determination unit may include: a rank map generator to determine ranks depending on brightness values of pixels in each of the low dynamic range images and generate a rank map based on the determined ranks; and motion detector to generate the motion map in which it is determined that motion has occurred in another image if a rank difference is larger than a critical value, and in which it is determined that motion has not occurred in the other image if the rank difference is less than the critical value.

The apparatus further includes a morphology calculator to cluster the motion map by applying a morphology calculation to the motion map.

The generator may calculate weights for contrast, saturation, and degree of exposure for each pixel of the plurality of low dynamic range images.

One or two of the weights may be used depending on a calculation time.

The weight for the contrast may be greatest for a pixel corresponding to an edge or texture in each of the low dynamic range images, the weight for the saturation may be greatest for a pixel having a clearer color in each of the low dynamic range images, and the weight for the degree of exposure may increase as an exposure value of a pixel approaches a medium value.

The fusion unit may fuse the plurality of low dynamic range images and the weight map by using a pyramid decomposition algorithm.

The fusion unit may perform Laplacian pyramid decomposition on the low dynamic range images, may perform Gaussian pyramid decomposition on the weight map, and may combine a result of the performed Laplacian pyramid decomposition and a result of the performed Gaussian pyramid decomposition.

By using the image processing method and apparatus according to the invention, it is possible to accurately detect motion area by using a rank map, and it is possible to obtain a wide dynamic range image at a higher operation speed. In addition, it is possible to reduce a possibility that a phenomenon such as color warping may occur, because the image processing method and apparatus directly fuses images without using a tone mapping process.

### BRIEF DESCRIPTION OF THE DRAWINGS

The above and other features and advantages of the invention will become more apparent in review of detail exemplary embodiments thereof with reference to the attached drawings, in which:

FIG. 1 is a block diagram of an image processing apparatus, according to an embodiment of the invention;

FIG. 2 is a block diagram of the image signal processor illustrated in FIG. 1, according to an embodiment of the invention;

FIGS. 3A-1 through 3A-3 are diagrams showing a plurality of low dynamic range images;

FIGS. 3B-1 through 3B-3 are diagrams showing rank maps of the low dynamic range images of FIGS. 3A-1 through 3A-3;

FIG. 4 is a diagram for explaining a morphology calculation, according to an embodiment of the invention;

FIGS. 5A through 5C illustrate images in which motion is determined and then removed using conventional motion detection methods;

FIG. 5D illustrates an image in which motion is determined and then removed using motion detection method according to an embodiment of the invention;

FIG. 6 is a flowchart illustrating an image processing method, according to an embodiment of the invention; and

FIG. 7 is a flowchart illustrating, in detail, the motion detecting method of FIG. 6.

### DETAILED DESCRIPTION

As the invention allows for various changes and numerous embodiments, particular embodiments will be illustrated in the drawings and described in detail in the written description. However, these do not limit the invention to particular modes of practice, and it will be appreciated that all changes, equivalents, and substitutes that do not depart from the spirit and technical scope of this disclosure are encompassed in the invention. In the description of the invention, certain detailed explanations are omitted when it is deemed that they may unnecessarily obscure the essence of the invention.

While such terms as “first,” “second,” etc., may be used to describe various components, such components must not be limited to the above terms. The above terms are used only to distinguish one component from another.

It is also to be understood that the terminology used herein is for the purpose of describing particular embodiments only, and is not intended to limit the invention. An expression used in the singular, such as “a,” “an,” and “the”, encompass plural references as well unless expressly specified otherwise. The terms “comprising”, “including”, and “having” specify the presence of stated features, numbers, steps, operations, elements, components, and/or a combination thereof but do not preclude the presence or addition of one or more other features, numbers, steps, operations, elements, components, and/or a combination thereof. The invention will now be described more fully with reference to the accompanying drawings, in which exemplary embodiments of the invention are shown. An identical or corresponding component is designated with the same reference numeral and a detailed description thereof will be omitted.

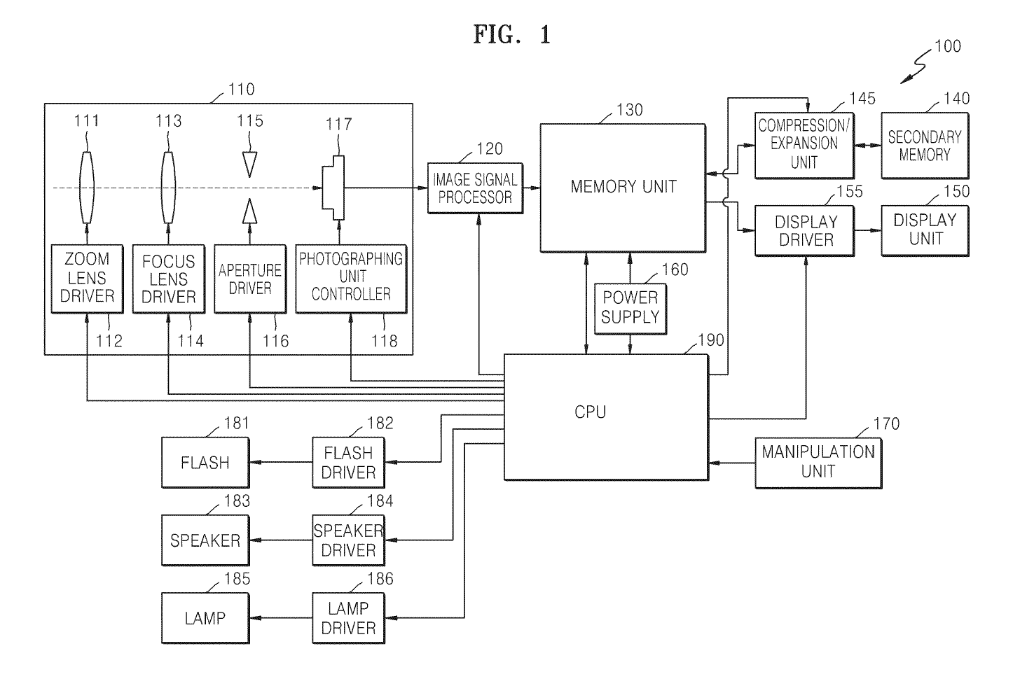

FIG. 1 is a block diagram of an image processing apparatus according to an embodiment of the invention. In the present embodiment, a digital camera 100 is used as an example of the image processing apparatus. However, the image processing apparatus according to the present embodiment is not limited thereto and may be a digital single-lens reflex (SLR) camera, a hybrid camera, or any device capable of processing images. Moreover, the disclosed image processing apparatus and methods may be implemented separately from a device used to capture and/or obtain low dynamic range images. The construction of the digital camera 100 will now be described in detail according to the operation of components therein.

First, a process of photographing a subject will be described. Luminous flux originating from the subject is transmitted through a zoom lens 111 and a focus lens 113 that are part of an optical system of a photographing device 110, and the intensity of the luminous flux is adjusted by the opening/closing of an aperture 115 before an image of the subject is focused on a light-receiving surface of a photographing unit 117. The focused image is then photoelectrically converted into an electric image signal.

The photographing unit 117 may be a charge coupled device (CCD) or a complementary metal oxide semiconductor image sensor (CIS) that converts an optical signal into an electrical signal. The aperture 115 is wide open in a normal mode or while an autofocusing algorithm is being executed upon reception of a first release signal produced by pressing a release button halfway. Furthermore, an exposure process may be performed upon reception of a second release signal produced by fully pressing the release button.

A zoom lens driver 112 and a focus lens driver 113 control the positions of the zoom lens 111 and the focus lens 113, respectively. For example, upon receipt of a wide angle-zoom signal, the focal lens of the zoom lens 111 decreases so the angle of view gets wider. Upon receipt of a telephoto-zoom signal, the focal length of the zoom lens 111 increases so the angle of view gets narrower. Since the position of the focus lens 113 is adjusted while the zoom lens 111 is held at a specific position, the angle of view is substantially unaffected by the position of the focus lens 113. An aperture driver 116 controls the extent to which the aperture 115 opens. A photographing unit controller 118 regulates the sensitivity of the photographing unit 117.

The zoom lens driver 112, the focus lens driver 114, the aperture driver 116, and the photographing unit controller 118 respectively control the zoom lens 111, the focus lens 113, the aperture 116, and the photographing unit 117 according to a result of operations executed by a CPU 190 based on exposure information and focus information.

A process of producing an image signal is described. The image signal output from the photographing unit 117 is fed into an image signal processor 120. If an image signal input from the photographing unit 117 is an analog signal, the image signal processor 120 converts the analog signal into a digital signal. The image signal processor 120 may perform image processing on the image signal. The resulting image signal is temporarily stored in a memory unit 130.

More specifically, the image signal processor 120 performs signal processing such as auto white balance, auto exposure, and gamma correction to improve image quality by converting input image data to a form suitable for human review and outputs a resulting image signal with improved quality. The image signal processor 120 also performs image processing such as color filter array interpolation, color matrix, color correction, and color enhancement.

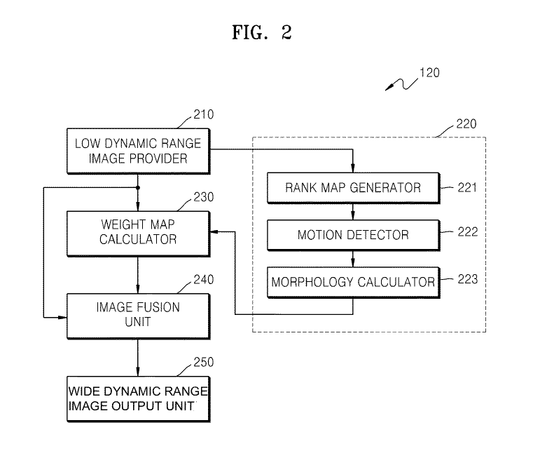

In particular, the image signal processor 120 decomposes a luminance value of a radiance map into a base layer and a detail layer; generates a weight using a ratio of the luminance value of the radiance map to the luminance value of the base layer; creates a compressed luminance value using the base layer, the detail layer and the weight; and produces a final tone-mapped image using color values of the radiance map, the luminance value of the radiance map, and the compressed luminance value. The operation of the image signal processor 120 will be described in more detail later with reference to FIGS. 2 through 5.

The memory unit 130 includes a program memory in which programs related to operations of the digital camera 100 are stored regardless of the state of a power supply, and a main memory in which the image data and other data are temporarily stored while power is being supplied.

More specifically, the program memory stores an operating system for operating the digital camera 100 and various application programs. The CPU 190 controls each component according to the programs stored in the program memory. The main memory temporarily stores an image signal output from the image signal processor 120 or a secondary memory 140.

Apart from supplying power to operate the digital camera 100, a power supply 160 may be connected directly to the main memory. Thus, codes stored in the program memory may be copied into the main memory or converted into executable codes prior to booting so as to facilitate booting of the digital camera 100. Furthermore, in the event of a reboot, requested data can be retrieved quickly from the main memory.

An image signal stored in the main memory is output to a display driver 155 and is converted into a form suitable for display. The resulting image signal is displayed on a display unit 150 so that a user can view the corresponding image. The display unit 150 may also serve as a view-finder that consecutively displays image signals obtained by the photographing unit 117 in a photographing mode and determines an area of the subject to be photographed. The display unit 150 may be a liquid crystal display (LCD), an organic light-emitting diode (OLED), an electrophoresis display device (EDD), or various other displays.

A process of recording the generated image signal is described. The image signal is temporarily stored in the memory unit 130. The image signal is also stored in the secondary memory 140, together with various information about the image signal. The image signal and the information are output to a compression/expansion unit 145.

The compression/expansion unit 145 forms an image file, such as a Joint Photographic Experts Group (JPEG) file, by performing a compressing process, such as an encoding process, on the image signal and information so that they are in an efficient format for storage, using a compressing circuit, and the image file is stored in the secondary memory unit 140.

The secondary memory 140 may be a stationary semiconductor memory such as an external flash memory, a card or stick type detachable semiconductor memory such as a flash memory card, a magnetic memory medium such as a hard disk or floppy disk, or various other types of memories.

A process of reproducing an image is described. The image file recorded on the secondary memory 140 is output to the compression/expansion unit 145. The compression/expansion unit 145 then performs expansion, i.e., decoding or decompression on the image file using an expansion circuit, extracts an image signal from the image file, and outputs the image signal to the memory unit 130. After temporarily storing the image signal in the memory unit 130, predetermined corresponding image is reproduced on the display unit 150 by the display driver 155.

The digital camera 100 further includes a manipulation unit 170 that receives signals and inputs from a user or an external input device. The manipulation unit 170 may include a shutter release button that causes a shutter to open or close exposing the photographing unit 117 to incoming light for a predetermined time, a power button for entering information in order to supply power, a wide angle-zoom button and a telephoto-zoom button for respectively widening and narrowing an angle of view according to an input, and various function buttons for selecting a text input mode, a photo taking mode, and a reproduction mode and for selecting a white balance setting function and an exposure setting function.

The digital camera 100 further includes a flash 181 and a flash driver 182 driving the flash 181. The flash 181 is used to momentarily illuminate a subject when taking photos in a dark place.

A speaker 183 and a lamp 185 respectively output an audio signal and a light signal to inform the user about the operation status of the digital camera 100. In particular, when photographing conditions initially set by the user in a manual mode change at the time when photography takes place, a warning tone or optical signal may be output through the speaker 183 or the lamp 185, respectively, to indicate such a change. A speaker driver 184 controls the speaker 183 to adjust the type and volume of audio output. A lamp driver 186 controls the lamp 185 to adjust light emission, a light emission time period, and the type of light emission.

The CPU 190 performs operations according to the operating system and application programs stored in the memory unit 130 and controls the components according to a result of the operations so that the digital camera 100 can operate as described above.

The configuration and operation of the image signal processor 120 according to an embodiment of the invention will now be described in detail with reference to FIGS. 2 through 7.

Referring to FIG. 2, the image signal processor 120 includes a low dynamic range image provider 210, motion determination unit 220, a weight map calculator 230, an image fusion unit 240, and a wide dynamic range image output unit 250. Here, motion determination unit 220 includes a rank map generator 221, a motion detector 222, and a morphology calculator 223.

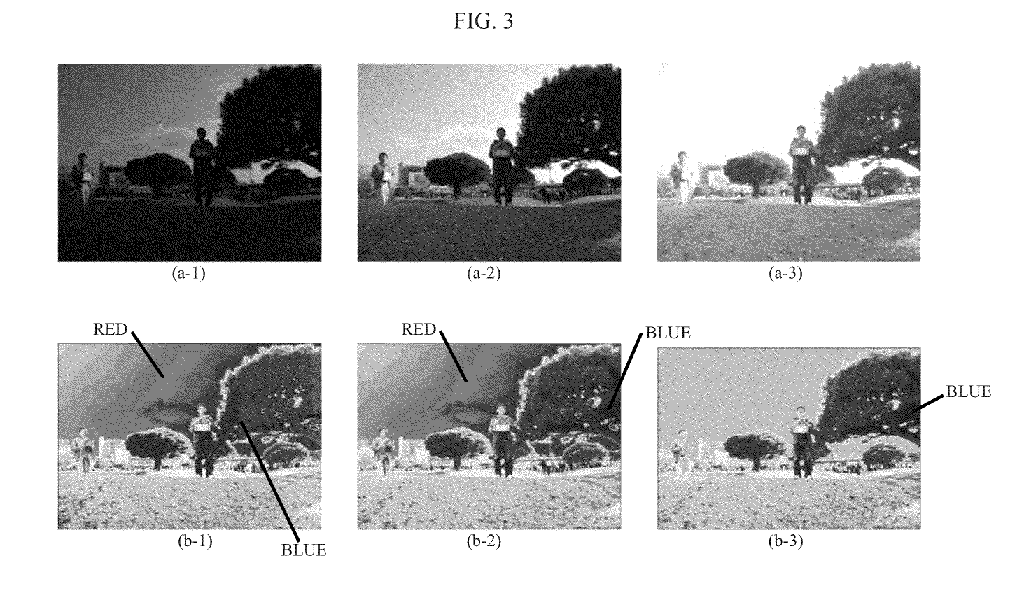

The low dynamic image provider 210 provides a plurality of low dynamic range images with different exposure levels for a same scene. The low dynamic range images mean images that may be obtained with exposure values that may be provided by the digital camera 100. According to an embodiment of the present invention, the low dynamic range images may be one or more images that are captured by changing an exposure time by using an auto exposure bracketing (AEB) function of the digital camera 100. Below, for convenience of explanation, the number of the low dynamic range images is limited to three. In detail, these three low dynamic range images correspond to a first image LDR1 captured in a condition of insufficient exposure by reducing the exposure time as illustrated in FIG. 3A-1, a second image LDR2 captured in a condition of proper exposure by making the exposure time be proper as illustrated in FIG. 3A-2, and a third image LDR3 captured in a condition of excessive exposure by increasing the exposure time as illustrated in FIG. 3A-3. However, the present invention is not limited thereto, and the low dynamic range images may be four or five images that are captured by changing the exposure time.

The motion determination unit 220 determines whether a motion is detected depending on a brightness rank, for the first image LDR1, the second image LDR2, and the third image LDR3 provided from the low dynamic image provider 210. As stated above, the motion determination unit 220 includes the rank map generator 221, the motion detector 222, and the morphology calculator 223.

The rank map generator 221 determines a rank depending on a brightness value of a pixel which is represented by values 0 through 255 for each of the first image LDR1, the second image LDR2, and the third image LDR3. If a rank of a position i of a pixel in a K-th exposure image (1≦k≦K) is “r_{i,k}”, the “r_{i,k}” is formalized using the following equation 1.

$${\hat{r}}_{i , k}^{l} = ( \frac{{r}_{i , k}^{l} - 1}{{R}_{i , k}^{l} - 1} \times {2}^{N} ) , 0 \leq {\hat{r}}_{i , k}^{l} \leq {2}^{N} - 1 \qquad ( 1 )$$

In equation 1, “R^{l}ₖ(=2^{N}−1)” is a final rank of the k-th exposure image. “N” may be determined depending on a hardware cost. The larger the value of “N” is, the better a quality of a final wide dynamic range image is, but the higher the hardware cost. In the case where the value of “N” is 8, rank maps for images of FIGS. 3A-1 through 3A-3 are illustrated in FIGS. 3B-1 through 3B-3. A high rank is indicated by a red color, and a low rank is indicated by a blue color. Through FIGS. 3B-1 through 3B-3, it is possible to confirm that rank maps of the low dynamic range images having different exposure levels are similar to each other in an area except for a motion area.

The motion detector 222 obtains a rank difference between a reference rank map and another rank map in a same pixel position, and determines whether a motion is detected, by comparing the rank difference to a critical value.

The rank difference between the reference rank map and another rank map in a same pixel position may be obtained by using the following equation 2.

d^{l}_{i,k=}|\hat{r}^{l}_{i,ref}−\hat{r}^{l}_{i,k}| (2)

In equation 2, “\hat{r}^{l}_{i,ref}” indicates a reference rank map of an i-th pixel position, and “\hat{r}^{l}_{i,k}” indicates a k-th rank map of the i-th pixel position. For example, the rank map of FIG. 3B-2 may be the reference rank map, and the rank map of FIG. 3B-1 or FIG. 3B-3 may be the k-th rank map. The rank difference is generated as many times as the number of rank map images. That is, the motion detector 222 obtains a rank difference between the rank map of FIG. 3B-2 and the rank map of FIG. 3B-1, a rank difference (the difference is 0) between the rank map of FIG. 3B-2 and itself, and a rank difference between the rank map of FIG. 3B-2 and the rank map of FIG. 3B-3. This method allows a motion of an object to be detected through a simple arithmetic operation while compensating for an exposure level difference between the low dynamic range images. Since an area, in which a motion of an object occurs, shows a large difference between ranks, motion detection may be determined by using a critical value T and the following equation 3.

$${M}_{i , k}^{l} = \{ \begin{matrix}0 , & for {d}_{i , k}^{l} \geq T , k \neq ref \\ 1 & otherwise\end{matrix} \qquad ( 3 )$$

In equation 3, a binary image “M^{l}_{i,k}” is a motion map indicating a subject motion of the i-th pixel and a background change, in a k-th exposure. A suffix “ref” means a low dynamic range image having a medium exposure level, that is, the image (FIG. 3B-2) captured in a condition of proper exposure by ensuring an appropriate exposure time, and a motion is detected based on the low dynamic range image having the medium exposure level. A pixel in which “M^{l}_{i,k}” is “0” belongs to a moving object, an area covered by the moving object, or a changing background, and a pixel in which “M^{l}_{i,k}” is “1” belongs to an area in which a motion does not occur.

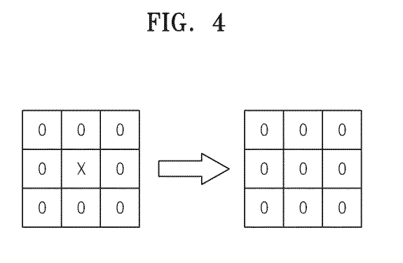

The morphology calculator 223 clusters the motion map “M^{l}_{i,k}” by applying a morphology calculation to the motion map “M^{l}_{i,k}”. Since a motion is detected based on a pixel unit, a same object may be determined as different motion areas. Thus, clustering is performed between areas in which similar motions occur, by using the morphology calculation. Referring to FIG. 4, the clustering, which is performed by using the morphology calculation, means checking a corresponding relation between a centered pixel and a surrounding pixel through a mask and then changing the centered pixel depending on a characteristic of the surrounding pixel. FIG. 4 illustrates a morphology calculation according to an embodiment of the present invention. A kind of the morphology calculation may vary, such as a dilation calculation for filling surrounding pixels around the centered pixel based on the centered pixel, an erosion calculation for performing a function opposite to the dilation calculation, an opening calculation, a closing calculation, and the like. A final motion map “M′^{l}ₖ” to which the morphology calculation is applied is output to the weight map calculator 230.

The weight map calculator 230 obtains weights for contrast C, saturation S, and degree of exposure E for each pixel of the first through third images LDR1, LDR2, and LDR3 which are provided from the low dynamic image provider 210. In addition, the weight map calculator 230 calculates a weight map “W^{l}_{i,k}” by combining the obtained weights and the motion map “M′^{l}ₖ” which is output from the motion determination unit 220 and in which the morphology calculation is performed. The weight map may be obtained by using the following equation 4.

W^{l}ₖ=(C^{l}ₖ)^{^{W}}^{C}×(S^{l}ₖ)^{^{W}}^{S}×(E^{l}ₖ)^{^{W}}^{E}×M′^{l}ₖ (4)

The contrast weight “C^{l}ₖ” of equation 4 uses an absolute value of a pixel value obtained by passing a pixel, in which R, G, and B values of each of the first through third images LDR1, LDR2, and LDR3 are converted to intensities, through a Laplacian filter, and the absolute value of a pixel value is obtained by using the following equation 5.

$${m}_{k} = \frac{( {R}_{k} + {G}_{k} + {B}_{k} )}{3} \qquad ( 5 )$$

Through equation 5, the contrast weight is more highly applied with respect to a pixel corresponding to an edge or texture in an image.

Next, the saturation weight “S^{l}ₖ” is calculated with R, G, and B standard deviation of a pixel position i in a k-th image, and is obtained by using the following equation 6.

$${S}_{i , k} = \frac{\sqrt{{( {R}_{i , k} - {m}_{i , k} )}^{2} + {( {G}_{i , k} - {m}_{i , k} )}^{2} + {( {B}_{i , k} - {m}_{i , k} )}^{2}}}{3} \qquad ( 6 )$$

Through equation 6, the saturation weight is more highly applied with respect to a pixel of which a color is clearer in an image.

Next, the degree of exposure weight “E^{l}ₖ” may be calculated by using the following equation 7.

$${E}_{i , k} = exp ( \frac{- {( {R}_{i , k} - 0.5 )}^{2}}{2 {σ}^{2 }} + \frac{- {( {G}_{i , k} - 0.5 )}^{2}}{2 {σ}^{2}} + \frac{- {( {B}_{i , k} - 0.5 )}^{2}}{2 {σ}^{2 }} ) \qquad ( 7 )$$

The degree of exposure weight is more highly applied as the pixel value approaches a medium value 128 between 0 and 255. That is, a higher weight is applied as the pixel value approaches 0.5 if normalized between 0 and 1. This allows a fused image to have a medium brightness level by applying a small weight to an excessively dark or bright pixel.

It is possible to control an extent in which the weights are reflected, through indexes W_{C}, W_{S}, W_{E} in equation 4, and it is possible to use only one weight or two weights in consideration of a calculation time. The weight map is normalized as given by the following equation 8.

$${\hat{W}}_{i , k}^{l} = \frac{{W}_{i , k}^{l}}{{\sum }_{k = 1}^{K} {W}_{i , k}^{l}} \qquad ( 8 )$$

The image fusion unit 240 fuses a weight map “Ŵ” normalized for the first through third images LDR1, LDR2, and LDR3, and the first through third images LDR1, LDR2, and LDR3. Here, if the normalized weight map “Ŵ” and the first through third images LDR1, LDR2, and LDR3 are linearly fused, the fused image is not natural. Thus, the normalized weight map “Ŵ” and the first through third images LDR1, LDR2, and LDR3 are fused by using a pyramid decomposition algorithm.

When performing the pyramid decomposition algorithm, Laplacian pyramid decomposition “L{I}” is performed on the first through third images LDR1, LDR2, and LDR3, and Gaussian pyramid decomposition “G{Ŵ}” is performed on the normalized weight map “Ŵ”. This fusion results in a wide dynamic range image that is expressed with a Laplacian pyramid, and is represented by the following equation 9.

$$L {\{ R \}}_{i}^{l} = {\sum }_{k = 1}^{K} G {\{ \hat{W} \}}_{i , k}^{l} L {\{ I \}}_{i , k}^{l} \qquad ( 9 )$$

The wide dynamic image output unit 250 reconstructs the wide dynamic range image expressed with the Laplacian pyramid in an original image size and then outputs a final wide dynamic range image.

Conventional methods obtain a final wide dynamic range image in which a motion is removed by combining a method of generating wide dynamic range image and a method of removing a motion. On the contrary, it is possible to obtain a high-speed wide dynamic range imaging effect by combining an image fusing process and a motion removing method. This motion removing method also may effectively remove a motion by using a rank map. In addition, it is possible to obtain, at a higher speed, an image in which detail is improved, by using multiple layers.

In general, when it is apparent that motions of a flat object are overlapped, it is difficult to detect an overlapped motion. However, in the present invention, it is possible to effectively detect a small motion of a flat object by using a rank map. In addition, conventional methods have a problem in that the effect of a wide dynamic range imaging decreases since conventional methods excessively determine the small motion as a motion area, whereas, in the present invention, it is possible to increase the effect of the wide dynamic range imaging by accurately detecting only a motion area. In addition, the method according to the present invention has a higher operation speed compared to the conventional methods. In addition, the method according to the present invention may reduce a possibility that a phenomenon such as color warping occurs, because the method according to the may reduce a possibility that a phenomenon such as color warping occurs, because the method according to the invention directly fuses images without using a tone mapping process.

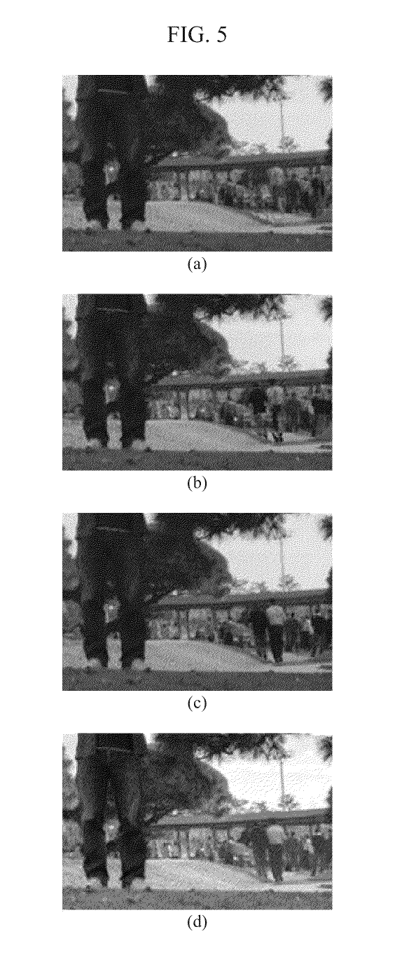

FIGS. 5A through 5D illustrate images for comparing results in which motion is determined and then removed. FIG. 5A illustrates an image in which motion is determined and then removed by using a dispersion-based motion detection method, and FIG. 5B illustrates an image in which motion is determined and then removed by using an entropy-based motion detection method. FIG. 5C illustrates an image in which motion is determined and then removed by using a histogram-based motion detection method, and FIG. 5D illustrates an image in which motion is determined and then removed by using motion detection method according to an embodiment of the invention. In FIGS. 5A through 5D, persons on the right side of each image correspond to a portion in which motion has occurred. Referring to FIG. 5D, it is possible to see that the motion has been better removed by the method according to the invention compared to the conventional methods of FIGS. 5A through 5C. It is possible to see that a wide dynamic range imaging effect according to the invention is greater in, for example, a part of the image showing the legs of a person on the left side of the image. Since the invention is a concept of expanding a median threshold bitmap (MTB) method of compensating a whole motion of a camera, an arithmetic operation speed may be improved if the MTB method is used in preprocessing steps.

As another embodiment, if a low dynamic range image used in the invention is used as an image sequence photographed under conditions of a same exposure of a high international standardization organization (ISO), it is possible to obtain an image in which noise is removed.

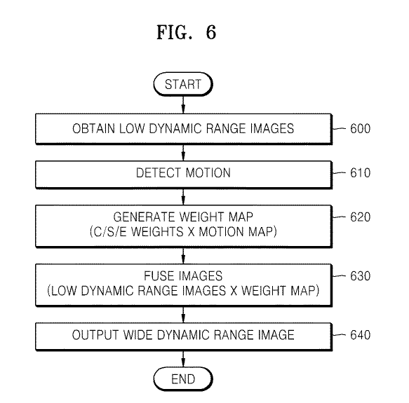

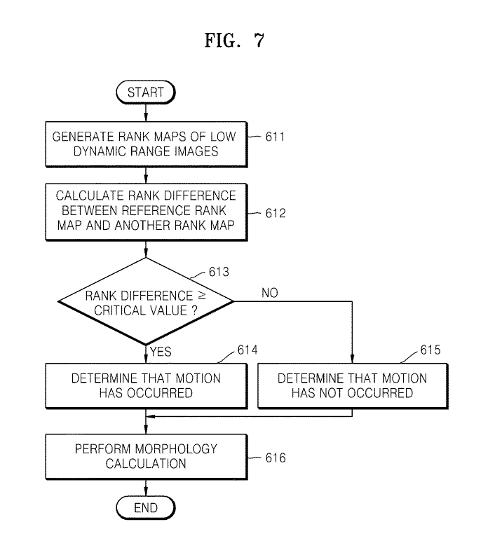

Furthermore, an image processing method according to the invention will now be explained with reference to FIGS. 6 and 7.

FIG. 6 is a flowchart illustrating an image processing method according to an embodiment of the invention. Referring to FIG. 6, the image signal processor 120 of FIG. 1 generates or obtains a plurality of low dynamic range images having different exposure levels for the same scene (operation 600). In addition, the image signal processor 120 determines an image overlap, that is, motion detection for the plurality of low dynamic range images (operation 610).

FIG. 7 is a flowchart illustrating, in detail, motion detecting method of FIG. 6. Referring to FIG. 7, the image signal processor 120 determines for each low dynamic range image a rank depending on a brightness value of a pixel, which is represented by values 0 through 255, for the plurality of low dynamic range images having different exposure levels, and then generates a rank map (operation 611).

After the rank maps are generated, the image signal processor 120 calculates rank differences between a reference rank map and other rank maps in a same pixel position (operation 612).

The image signal processor 120 determines whether the calculated rank difference is larger than a critical or threshold value T (operation 613). Since an area in which motion of an object occurs shows a large difference between the ranks, motion detection may be determined by using the critical value T.

The image signal processor 120 generates motion map in which it is determined that motion has occurred if the rank difference is larger than the critical value T (operation 614), and generates motion map in which it is determined that motion has not occurred in other images if the rank difference is less than the critical value T (operation 615).

After the motion maps are generated, the image signal processor 120 clusters the motion maps by applying a morphology calculation to the motion maps (operation 616).

Referring back to FIG. 6, the image signal processor 120 obtains weights for the contrast C, the saturation S, and the degree of exposure E for each pixel of the plurality of low dynamic range images, and generates a weight map by combining the obtained weights and the morphology-calculated motion map (operation 620).

The weight for the contrast is more highly applied with respect to a pixel corresponding to an edge or texture in each of the low dynamic range images. The weight for the saturation is more highly applied with respect to a pixel whose color is clearer in each of the low dynamic range images. The weight for the degree of exposure is more highly applied as the pixel value approaches 0.5 if normalized between 0 and 1. Here, it is possible to use only one weight or two weights in consideration of a calculation time.

After the weight map is generated, the image signal processor 120 fuses the plurality of low dynamic range images and a normalized weight map (operation 630). Here, if the plurality of low dynamic range images and the normalized weight map are linearly fused, the fused image is not natural. Thus, a pyramid decomposition algorithm is used. In detail, a Laplacian pyramid decomposition is performed on the plurality of low dynamic range images, and a Gaussian pyramid decomposition is performed on the normalized weight map. This fusion result becomes a wide dynamic range image that is expressed with a Laplacian pyramid.

Next, the image signal processor 120 reconstructs the wide dynamic range image expressed with the Laplacian pyramid in an original image size and then outputs a final wide dynamic range image (operation 640).

The embodiments disclosed herein may include a memory for storing program data, a processor for executing the program data to implement the methods and apparatus disclosed herein, a permanent storage such as a disk drive, a communication port for handling communication with other devices, and user interface devices such as a display, a keyboard, a mouse, etc. When software modules are involved, these software modules may be stored as program instructions or computer-readable codes, which are executable by the processor, on a non-transitory or tangible computer-readable media such as a read-only memory (ROM), a random-access memory (RAM), a compact disc (CD), a digital versatile disc (DVD), a magnetic tape, a floppy disk, an optical data storage device, an electronic storage media (e.g., an integrated circuit (IC), an electronically erasable programmable read-only memory (EEPROM), a flash memory, etc.), a quantum storage device, a cache, and/or any other storage media in which information may be stored for any duration (e.g., for extended time periods, permanently, for brief instances, for temporary buffering, for caching, etc.). As used herein, a computer-readable storage medium expressly excludes any computer-readable media on which signals may be propagated. However, a computer-readable storage medium may include internal signal traces and/or internal signal paths carrying electrical signals thereon.

Any references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of this disclosure, reference has been made to the embodiments illustrated in the drawings, and specific language has been used to describe these embodiments. However, no limitation of the scope of this disclosure is intended by this specific language, and this disclosure should be construed to encompass all embodiments that would normally occur to one of ordinary skill in the art in view of this disclosure.

Disclosed embodiments may be described in terms of functional block components and various processing steps. Such functional blocks may be realized by any number of hardware and/or software components configured to perform the specified functions. For example, the embodiments may employ various integrated circuit components (e.g., memory elements, processing elements, logic elements, look-up tables, and the like) that may carry out a variety of functions under the control of one or more processors or other control devices. Similarly, where the elements of the embodiments are implemented using software programming or software elements, the embodiments may be implemented with any programming or scripting language such as C, C++, Java, assembler, or the like, using any combination of data structures, objects, processes, routines, and other programming elements. Functional aspects may be implemented as instructions executed by one or more processors. Furthermore, the embodiments could employ any number of conventional techniques for electronics configuration, signal processing, control, data processing, and the like. The words “mechanism” and “element” are used broadly and are not limited to mechanical or physical embodiments, but can include software routines in conjunction with processors, etc.

The particular implementations shown and described herein are illustrative examples and are not intended to otherwise limit the scope of this disclosure in any way. For the sake of brevity, conventional electronics, control systems, software development, and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the embodiments unless the element is specifically described as “essential” or “critical”.

The use of the terms “a,” “an,” “the,” and similar referents in the context of describing the embodiments (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. The steps of all methods described herein can be performed in any suitable order unless otherwise indicated herein or otherwise clearly contradicted by context. Moreover, one or more of the blocks and/or interactions described may be changed, eliminated, sub-divided, or combined; and disclosed processes may be carried out sequentially and/or carried out in parallel by, for example, separate processing threads, processors, devices, discrete logic, circuits, etc. The examples provided herein and the exemplary language (e.g., “such as” or “for example”) used herein are intended merely to better illuminate the embodiments and does not pose a limitation on the scope of this disclosure unless otherwise claimed. In view of this disclosure, numerous modifications and adaptations will be readily apparent to those skilled in this art without departing from the spirit and scope of this disclosure.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method of processing an image, the method comprising:
obtaining a plurality of low dynamic range images having different exposure levels for a same scene;
generating motion map representing whether motion occurred, depending on brightness ranks of the plurality of low dynamic range images;
obtaining weights for the plurality of low dynamic range images;
generating a weight map by combining the weights and the motion map; and
generating a wide dynamic range image by fusing the plurality of low dynamic range images and the weight map.

2. The method of claim 1, wherein the determining whether the motion occurs comprises:
determining ranks depending on brightness values of pixels in each of the low dynamic range images;
generating a rank map based on the determined ranks;
obtaining a rank difference between a reference rank map and another rank map in a same pixel position; and
generating the motion map in which it is determined that motion has occurred in another image if the rank difference is larger than a critical value, and in which it is determined that motion has not occurred in the other image if the rank difference is less than the critical value.

3. The method of claim 2, further comprising clustering the motion map by applying a morphology calculation to the motion map.

4. The method of claim 1, wherein the generating of the weight map comprises calculating weights for contrast, saturation, and degree of exposure for each pixel of the plurality of low dynamic range images.

5. The method of claim 4, wherein one or two of the weights are used depending on a calculation time.

6. The method of claim 4, wherein the weight for the contrast is greatest for a pixel corresponding to an edge or texture in each of the low dynamic range images, the weight for the saturation is greatest for a pixel having a clearer color in each of the low dynamic range images, and the weight for the degree of exposure increases as an exposure value of a pixel approaches a medium value.

7. The method of claim 1, wherein the generating of the wide dynamic range image comprises fusing the plurality of low dynamic range images and the weight map using a pyramid decomposition algorithm.

8. The method of claim 1, wherein the generating of the wide dynamic range image comprises:
performing Laplacian pyramid decomposition on the low dynamic range images;
performing Gaussian pyramid decomposition on the weight map; and
combining a result of the performed Laplacian pyramid decomposition and a result of the performed Gaussian pyramid decomposition.

9. An apparatus for processing an image, the apparatus comprising:
a provider to obtain a plurality of low dynamic range images having different exposure levels for a same scene;
a determination unit to generated motion map representing whether motion is detected depending on brightness ranks of the plurality of low dynamic range images;
a generator to obtain weights for the plurality of low dynamic range images and generate a weight map by combining the weights and the motion map; and
a fusion unit to generate a wide dynamic range image by fusing the plurality of low dynamic range images and the weight map.

10. The apparatus of claim 9, wherein the determination unit comprises:
a rank map generator to determine ranks depending on brightness values of pixels in each of the low dynamic range images and generate a rank map based on the determined ranks; and
motion detector to generate the motion map in which it is determined that motion has occurred in another image if a rank difference is larger than a critical value, and in which it is determined that motion has not occurred in the other image if the rank difference is less than the critical value.

11. The apparatus of claim 10, further comprising a morphology calculator to cluster the motion map by applying a morphology calculation to the motion map.

12. The apparatus of claim 9, wherein the generator calculates weights for contrast, saturation, and degree of exposure for each pixel of the plurality of low dynamic range images.

13. The apparatus of claim 12, wherein one or two of the weights are used depending on a calculation time.

14. The apparatus of claim 12, wherein the weight for the contrast is greatest for a pixel corresponding to an edge or texture in each of the low dynamic range images, the weight for the saturation is greatest for respect to a pixel having a clearer color in each of the low dynamic range images, and the weight for the degree of exposure increases as an exposure value of a pixel approaches a medium value.

15. The apparatus of claim 9, wherein the fusion unit fuses the plurality of low dynamic range images and the weight map by using a pyramid decomposition algorithm.

16. The method of claim 15, wherein the fusion unit performs Laplacian pyramid decomposition on the low dynamic range images, performs Gaussian pyramid decomposition on the weight map, and combines a result of the performed Laplacian pyramid decomposition and a result of the performed Gaussian pyramid decomposition.
